(19) United States
(12) Patent Application Publication
(10) Pub. No.: US 2012/0112099 A1
(43) Pub. Date: May 10, 2012

(54) SYSTEM AND METHOD FOR THE IDENTIFICATION OF RADIATION IN CONTAMINATED ROOMS

(75) Inventors: Jody Rustyn Coleman, Aiken, SC (US); Eduardo B. Farfan, Aiken, SC (US)

(73) Assignee: Savanna River Nuclear Solutions, LLC, Aiken, SC (US)

(21) Appl. No.: 13/292,739

(22) Filed: Nov. 9, 2011

Related U.S. Application Data
(60) Provisional application No. 61/411,753, filed on Nov. 9, 2010.

(51) Int. Cl. G01T 1/08; G01T 1/02

(52) U.S. Cl. 250/473.1; 250/482.1

(57) ABSTRACT

Devices and methods for the characterization of areas of radiation in contaminated rooms are provided. One such device is a collimator with a collimator shield for reducing noise when measuring radiation. The determination system uses a radiation detector comprising a plurality of overlapping layers of radiation sensitive film interspersed with adjacent layers of an attenuator material. The resulting sandwich of the stacked film layers and attenuator layers provides a useful detector. The detector can be used within a radiation detector apparatus having a collimator to enable a 360 degree field of view of radiation sources within a room or enclosed environment.

### CROSS REFERENCE TO RELATED APPLICATION

This application claims the benefit of U.S. application Ser. No. 61/411,753 filed on Nov. 9, 2010 and entitled, “Hot Cell/Glovebox Characterization Using FRID™, RadCrystal™, and GrayQb.” U.S. application Ser. No. 61/411,753 is incorporated by reference herein in its entirety for all purposes.

This application relates to PCT/US11/38250 filed Aug. 18, 2011 entitled “System and Method for the Identification of Radiation in Contaminated Rooms” and which is incorporated herein by reference.

### STATEMENT AS TO RIGHTS TO INVENTIONS MADE UNDER FEDERALLY SPONSORED RESEARCH AND DEVELOPMENT

This invention was made with Government support under Contract No. DE-AC09-08SR22470 awarded by the United States Department of Energy. The Government has certain rights in the invention.

### FIELD OF THE INVENTION

The present invention relates generally to the characterization of areas such as shielded cells (hot cells), glove boxes, and rooms contaminated by radioactive materials involving gamma-ray, alpha-particle and neutron emitters. More particularly, the present application involves radiation characterizing devices employing highly-sensitive Phosphor Storage Plate (PSP) detection materials. The radiation characterizers provide the capability of determining the location, intensity, and energy of contamination as well as systems for visually highlighting contaminated areas as set forth in Applicant's co-pending PCT/US11/28250 filed Aug. 18, 2011 entitled “System and Method for the Identification of Radiation in Contaminated Rooms” in which incorporated herein by reference.

### BACKGROUND OF THE INVENTION

The use of radioactive material may result in the contamination of reactors, fuel and isotope processing facilities, laboratories, glove boxes, isolators, and other rooms. These facilities are usually associated with extremely high dose rates and, therefore, it is imperative to use remote technologies for characterization and decommissioning to keep worker exposures as low as reasonably achievable in these highly contaminated environments. A critical initial step in planning and implementing decontamination and decommissioning of contaminated facilities involves the development of an accurate assessment of the radiological, chemical, and structural conditions inside of the facilities. These conditions are often unknown for many of these facilities. Radiological and chemical contamination, as well as structural deterioration of such facilities presents risks to workers, which must be mitigated. To the extent that information can be collected to describe facility conditions using remote technologies, the conservatism associated with planning initial worker entry (and associated cost) can be reduced.

For facilities confirmed to be high hazard, remote and robotic technologies for characterization, decontamination and decommissioning can further reduce the costs to mitigate worker risks.

There is a need to develop better detector systems and processes to characterize and locate unidentified sources of radiation such as hot spots within gloveboxes, hot cells, and other confined spaces where elevated radiation levels exist.

Decontamination efforts of these rooms benefit from knowledge of where in the room radioactive contamination is located. A worker may concentrate his or her decontamination efforts on portions of the room that are actually contaminated while avoiding those areas that are already clean thus saving time, effort, money and exposure to radiation. Identification of radioactive contamination in a room may be accomplished through the use of a collimator that includes a detector made of a radiosensitive detector material that is housed within the collimator shield. The collimator shield defines at least one through aperture(s). The collimator may be placed within a room that is contaminated with radioactive material for a time sufficient to allow portions of the detector to become exposed or otherwise modified via exposure to the radiation contamination. The apertures of the collimator shield function to allow radiation into the detector so that exposure images are formed. The degree of the exposed image and the location of exposure on the image yield information on the intensity of the radiation and its direction. The collimator shield functions to block out radiation either completely or partially so that portions of the detector are not exposed to better allow this determination.

Although existing techniques are available for ascertaining the location and intensity of radiation contamination within a room, such techniques are subjective in nature, costly, not efficient, limited in application, not automatic, and inaccurate. As such, there remains room for variation and improvement in the art.

### SUMMARY OF THE INVENTION

It is one aspect of at least one of the present embodiments to provide for a radiation detector for characterization of gamma-ray, alpha-particle and neutron emitters present within a location such as a shielded cell, glove box or room.

It is a further aspect of at least one of the present embodiments to provide for a plurality of film layers positioned between opposing layers of attenuator materials so as to provide a sandwich type construction of a film detector having a broad range of sensitivity to gamma-ray, alpha-particle and neutron emitters.

It is a further aspect of at least one of the present embodiments to provide for a radiation detector having a plurality of film layers positioned between opposing layers of radiation attenuation materials which can provide for a rapid screening tool for the detection and identification of one or more of a gamma-ray, alpha-particle and/or neutron emission source present in proximity to the detector.

It is a further aspect of at least one of the present embodiments to provide for a plurality of film layers positioned between opposing layers of radiation attenuation materials which can provide for a dosimeter which may be worn by personnel working in proximity to radiation sources or deployed as a screening tool within a “hot” environment.

It is a further aspect of at least one of the present embodiments to provide for a radiation detecting apparatus comprising:

a housing defining an interior surface and an exterior surface, the housing further defining a plurality of collimators extending from the outer surface to the inner surface; and,

a radiosensitive detector positioned along the interior of the housing and in further communication with the plurality of collimators, the radiosensitive detector comprising multiple layers of radiation sensitive films positioned between alternating layers of attenuators.

It is a further aspect of at least one of the present embodiments to provide for a radiation detecting apparatus having a housing, the housing defining a plurality of faces, each of the plurality of faces defining a unique plane relative to the other faces;

a receptacle defined within each face, the receptacle adapted for retaining therein a radiation detector; and

a collimator positioned opposite each receptacle, each collimator comprising an opening perpendicular to the respective plane defined by the face of the housing; wherein, when a radiation detector is placed within at least one of the receptacles, the radiation detector will receive radiation passing through the opening defined within the collimator.

It is a further aspect of at least of the present embodiments to provide for a radiation detection apparatus defining a housing defining a plurality of facets and unique planes, each facet adapted for operatively engaging a radiation detector material positioned within a plane of each of said facets in shape of said housing further adapted for engaging a plurality of collimators.

It is a further aspect of at least one of the present embodiments to provide for radiation detection apparatus defining a multi-faceted surface in which the exterior surfaces of the apparatus is provided by a radiation shielding material such as tungsten or a tungsten alloy.

It is a further aspect of at least one of the present embodiments to provide for a radiation detection apparatus in which the apparatus is in the form of a cube, each surface of the cube defining a receptacle therein for housing a radiation detector material and the receptacle further defining a covering of a collimator.

It is a further aspect of at least one of the present embodiments to provide for a radiation detection apparatus in which a radiation detector housed therein comprises a plurality of film layers and in which at least some of the film layers are separated by an intervening layer of a radiation attenuation material.

It is a further aspect of at least one of the present embodiments to provide for a radiation detection apparatus which defines a plurality of facets in unique planes, each facet adapted for operatively engaging a radiation detector material comprising at least one film layer housed therein and a collimator positioned opposite the radiation detector, the collimator in selective communication with a radiation blocking shutter responsive to at least one of a timer or a switching mechanism such that the collimator's exposure to radiation may be controlled by the operation of the shutter from a first blocking position to an open position.

It is a further aspect of at least one of the present embodiments to provide for radiation detection apparatus defining a multi-faceted surface in which the exterior surfaces of the apparatus is provided by a radiation shielding material such as tungsten or a tungsten alloy and an interior body portion of the apparatus is formed of aluminum or alloy of aluminum.

It is a further aspect of at least one of the present embodiments to provide for a radiation detection apparatus defining at least 6 multi-faceted exterior surfaces and each surface facet defining therein a receptacle for containing a radiation detector; and,

a collimator positioned over a surface facet such that an opening defined within the collimator is perpendicular to a surface of the radiation detector, the collimator further defining a 96 degree field of view.

It is a further aspect of at least one of the present embodiments to provide for a process of detection and identification of one or more of a gamma-ray, alpha-particle, beta-particle, and/or neutron emission source present in a multi-surfaced environment such as a reactor, fuel and isotope processing facilities, laboratories, glove boxes, isolators, and outdoor environments, comprising the steps of:

deploying a radiation detection apparatus defining a plurality of multi-faceted exterior surfaces and each surface facet defining therein a receptacle having a radiation detector therein, the radiation detector defining multiple film layers separated by intervening layers of an attenuator and the radiation detector in further communication with a collimator;

exposing each radiation detector to ambient conditions for a controlled period of time;

processing said radiation detector to determine information of at least one of a type, quantity, or location of a radiation source present with the environment in which the radiation detection apparatus was deployed.

It is a further aspect of at least one of the present embodiments to provide for a process of detection and identification of one or more of a gamma-ray, beta-particle, alpha-particle and/or neutron emission source present in a multi-surfaced environment in which information from a plurality of radiation detectors are used to provide a location and identity of radiation sources, the step of providing a location further including projection of the source information overlay onto the map or photograph of the examined room. Such apparatuses and processes facilitate an ability to provide 3D characterizations of the affected areas while having valuable properties that include low cost, robustness, and stability against falls, impacts, and extreme temperatures. In addition, the systems are remotely deployable during the measurement/characterization process and require no connecting power, communication cords or connection to other electronic devices. The portability, sensitivity and small size of the apparatus will facilitate the measurement and mapping in areas of a facility, which were previously considered physically inaccessible with traditional electrical-based radiation detection systems. An apparatus and process described herein offers an inexpensive and safer means to perform initial radiological characterizations, in-process surveys, and final status surveys to enable effective decontamination while minimizing exposures to workers.

This present invention relates further to a complete characterization of hot cells, gloveboxes, rooms and field locations contaminated with gamma-ray, alpha-particle, beta-particle, and neutron emitters by deploying a characterizer device, used to 1) locate the contaminated areas within a contaminated area, 2) identify/differentiate the radionuclide's in these areas, and 3) quantify the intensity of the contamination. The present invention also includes use of a an improved detector material that may be arranged into a stack or ‘sandwich’ which, if there are attenuating materials among the detector film/plates, can provide energy discrimination of the source. The invention further allows for a radiation detection apparatus that enables a full 360 degree top-to-bottom room characterization (4π-steradian field of view). This device takes advantage of the high sensitivity of the film/PSPs and provides a means of collimating the radiation that is detected to allow location determination.

These and other features of the present invention, including the best mode thereof to one of ordinary skill in the art, is set forth more particularly in the remainder of the specification, including reference to the accompanying drawings.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective exploded view of a radiation detector formed of multiple film layers in accordance with one exemplary embodiment.

FIG. 2 is a perspective view of a radiation detection apparatus defining a plurality of multi-faceted surfaces in accordance with one exemplary embodiment.

FIG. 3 is a perspective view of a radiation detection apparatus, similar to that seen in FIG. 2, with a collimator positioned over a film detector receiving receptacle.

FIG. 4 is a perspective view similar to the views of FIGS. 2-3 showing motorized positionable shutters in engagement with a collimator.

FIG. 5 is a perspective view of a close up of the postionable shutter seen in FIG. 4.

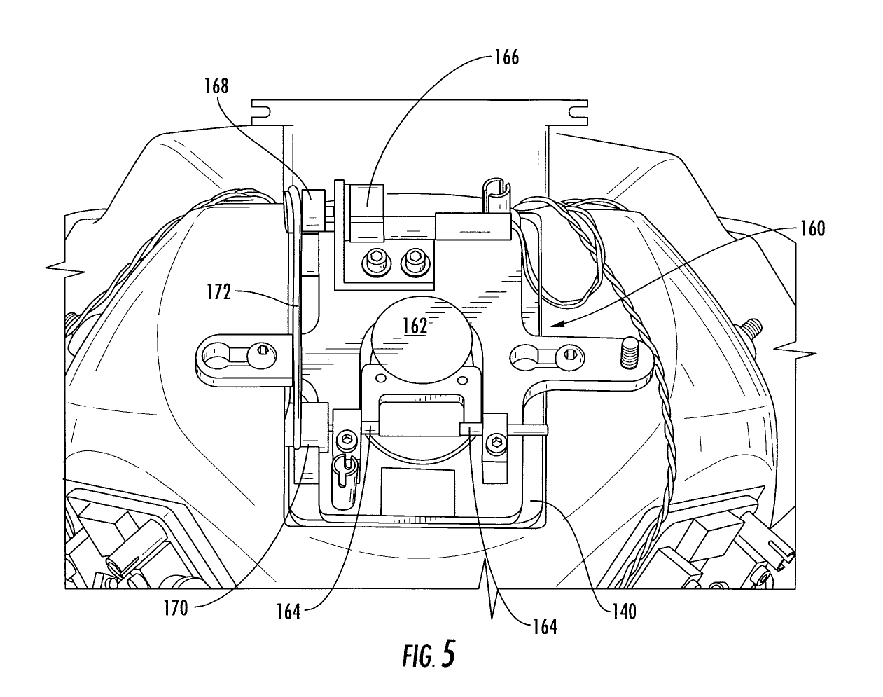

FIG. 6 is a perspective view similar to FIGS. 2-4 illustrating a protective cap that may be used with the radiation detection apparatus during deployment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

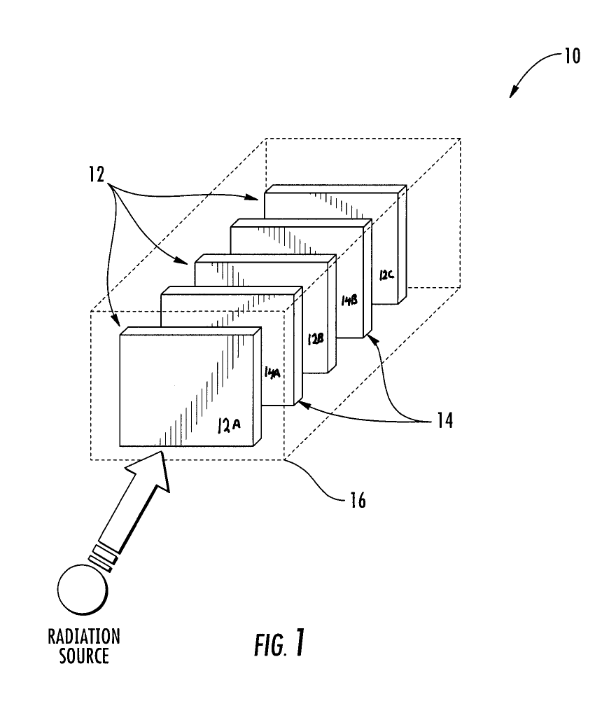

A radiation detector 10 can be used to measure intensity of radioactive material in a contaminated room. The detector 10 may include a plurality of radiation sensitive film layers 12 that are configured as seen in FIG. 1 into a stacked array. Interspersed with the film layers are individual layers of an attenuator 14 that provides for a controlled reduction of radiation intensity that passes through the detector 10. When assembled within a holder 16, the detector 10 provides for multiple film layers 12 that are sensitive to radiation. Holder 16 facilitates the insertion and removal of the film/PSP layers. As best described below, a collimator may be used to channel the direction of radiation exposure onto the detector 10 into lines so that one may more easily ascertain the location and intensity of radiation that may be present.

Suitable films used in this invention can be the type used in the medical field, or it could be specific models that are employed for non-destructive testing (NDT) in a variety of industrial settings. The films can be of a traditional photographic type or could be the newer Phosphorous Storage Plate (PSP) technology that is used in modern Computed Radiography (CR). In nearly all medical or industrial cases, the source of the radiation is known to the user and there is no interest in determining either the energy of the incident radiation or the location of the source. This invention uses an apparatus and process for determining the energy of the source photons using a film-based radiation detector.

The output of a film, defined broadly to include PSP substrates, is simply a matrix of scaled numbers, between zero exposure and the upper limit of the film, typically in a 2D matrix and displayed as an image. In terms of a traditional X-ray film, the 2D matrix of exposure values for a processed film ranges from pure white being unexposed to pure black representing full exposure of the film area. Gradations between the pure white and black values can be numerically interpreted as intermediate values on the continuum between a zero exposure and an exposure to radiation at an intensity that saturates the film to its maximum value.

Each type of film has a particular response to incident energy radiation. Most films are extremely sensitive to lower energy gamma radiation, while less sensitive to higher energy gammas. The older photographic films have an “S” shaped response, having a relatively flat response on the low end, a sharp drop off of sensitivity as energy increases, then a relatively flat (and less sensitive) high end. PSP type films have a much more linear response, slowly dropping in sensitivity as incident energy increases. The response of the film to be used at various energies should be determined when employing this technology.

Since a film can only provide a scaled exposure value, a user cannot determine (with only one film) the source or intensity of the incident radiation. For example, a high activity source giving high energy gammas can produce a similar image to a low activity source giving low energy gammas. This is because the films are much more sensitive at lower energies, so the lower activity source with lower energy gammas can yield a similar image.

As seen in FIG. 1, an arrangement of multiple film layers 12, stacked in a ‘sandwich’, with some amount of attenuating material 14 between them is provided. This material could be metal, plastic, glass, etc., and can be nearly any thickness needed. The exact number of films used in the sandwich and materials (and thickness) is adjustable, depending on the amount of resolution needed in the energy discrimination.

For example, when a low energy gamma source is exposed to the detector 10, the outer film 12A is directly exposed to the source and, since the source energy is low, will receive a relatively large exposure from the source. The incident radiation will also penetrate this outer film and enter the first attenuator 14A. After penetrating attenuator 14A, the incident radiation will also expose the second film 12B. If the attenuator material and thickness is chosen carefully, the second film 12B will receive less exposure than the first film, but the attenuator should not completely shield the second film. The exposures of both films can be represented by a percentage difference and by the actual exposure values. By way of example, if film layer 12B's exposure is 50% less than layer 12 A, knowing the attenuation coefficient and thickness of the attenuator between films, one can determine at what energy the attenuator shielded 50% of incident radiation. Knowing the incident energy, one can also determine the intensity of the incident radiation based on the exposure levels of the films by knowing the response of the films at various energies.

This sandwich can be expanded into many layers with various attenuator materials, to give a broad range of energies that can be discriminated, or to give very accurate energy values. If desired, a single attenuator can be provided that has varying density across the face of the attenuator. By correlation of the position of the film layer to the location with respect to a variable density attenuator, a single film layer can record a greater range of energy values. Such a configuration may be useful for a rapid determination of energy thresholds values such that a more detailed analysis can be conducted using appropriate configurations of film layers 12 and attenuators 14 when deployed on a radiation detection apparatus as provided below.

In addition to the uses within a radiation detection apparatus as detailed below, the radiation detector 10 may be used as a dosimeter or film badge to measure radiation exposure. Suitable readers for film or PSP plates as utilized herein can be obtained from Air Techniques, Inc (Melville, N.Y.) such as ScanX brand imaging systems. Air Techniques, Inc can provide flexible PSP plates as well as traditional X-ray films along with suitable readers and processing equipment which allow immediate transfer of scanned data to a computer for further data processing.

As described in applicant's co-pending application PCT/US11/38250 filed Aug. 18, 2011 entitled “System and Method for the Identification of Radiation in Contaminated Rooms” an apparatus and method of using a radiosensitive PRESAGE™ polymer detector material is disclosed. The PRESAGE™ polymer is available from Heuris Pharma (Skillman, N.J.) and has been widely studied in a number of published reports. However, the sensitivity of polymer material is too low for many deployment locations since data accumulation would necessitate deployment intervals of measured in terms of months to years. The PSP technology is roughly 30,000 times more sensitive than the polymers, reducing the deployment time and analysis of the data to a few minutes to hours.

Several PSPs or traditional film layers can be arranged into a semi-spherical shape (as a substitute to the RadBall™ PRESAGE™ polymer) and preferably includes the multiple layer arrangement with attenuators 14 as seen in FIG. 1 to allow energy discrimination. The sensitivity of a film or PSP equivalent boosts the RadBall™'s sensitivity to a level that makes it suitable for many more deployment areas, particularly in very low dose environments such as environments characterized by ˜1 milli Roentgen per hour (˜1 mR/hr). As seen in reference to FIG. 1, the detector comprises several layers of film and attenuator materials, as well as structural components to provide a way of handling the detector. If desired the detector 10 may be formed in a semi-spherical shape with an outer layer of films arranged in a somewhat semi-spherical shape, covering a layer of some gamma attenuating material, followed by an additional film layer, with possibly a third film/attenuator layer. The layers are separable, so that the inner films can be retrieved. The films themselves may be of various shapes to provide as closely as possible a spherical shape.

After an exposure, the individual films are removed from the structural support material. The films are then scanned into a computer to be analyzed. The analysis of the films provides information on location of the contamination. In addition, the films also accurately provide the intensity (e.g., dose rates) and photon energy (e.g., radionuclide differentiation) of the contamination.

Since the detector material configured for use in RadBall™ device is in the form of a thin film, the interior of the semicircular sphere-shaped detector may include a shielding material such as tungsten, aluminum, or a combination of these materials such that radiation can only enter a detector from a single, known direction as provided by the collimator. The polymer material previously used could not easily discriminate between radiation paths which were on parallel paths but were transmitted from opposite directions. By limiting radiation exposure of the detectors to radiation originating from a single, known direction, the information from the detector material can be more easily analyzed. Further, since the polymer type radiation detectors would visualize tracks running through the polymer from multiple directions, the subsequent data analysis was time intensive. The minimization of radiation tracks from sources not originating though a specified collimator, greatly simplifies data analysis.

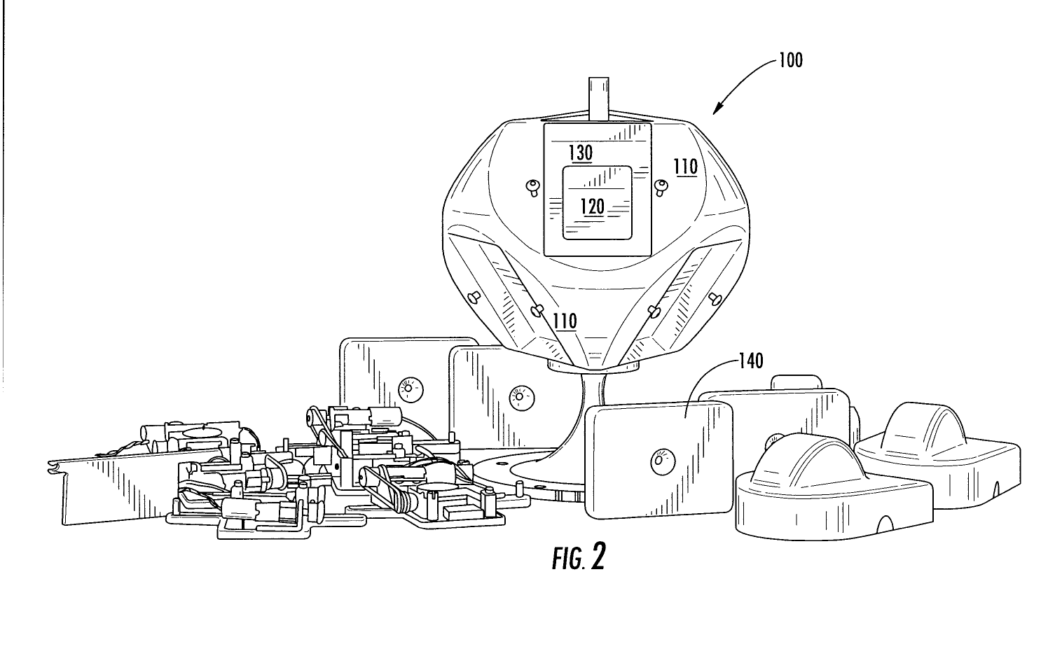

The improvements associated with a film/PSP type detector allows an improved radiation detection apparatus to be constructed which requires as few as 6 collimators with a similar number of detectors to achieve a 360 degree detection within a multi-surfaced environment. As best seen in reference to FIG. 2, a radiation detection apparatus 100 is provided. In the illustrated embodiment, the apparatus 100 is in the form of a six sided cube. An exterior surface of the cube is formed of a radiation shielding material such as tungsten or a tungsten alloy. It has been found that a tungsten layer of about 1.5 cm inches/cm will provide adequate shielding such that only radiation passing through an associated collimator will interact with an associated radiation detector. The interior body of the apparatus 100 can be made of aluminum or aluminum alloys. The aluminum provides for a lighter weight apparatus that facilitates mechanical deployment and positioning. In attention, the aluminum has sufficient density/attenuation properties, such that radiation which may pass through a detector housed within apparatus 100, will be stopped by the aluminum core. In this manner, a detector is prevented from receiving radiation from opposite directions which would complicate the calculation of data from the detector film.

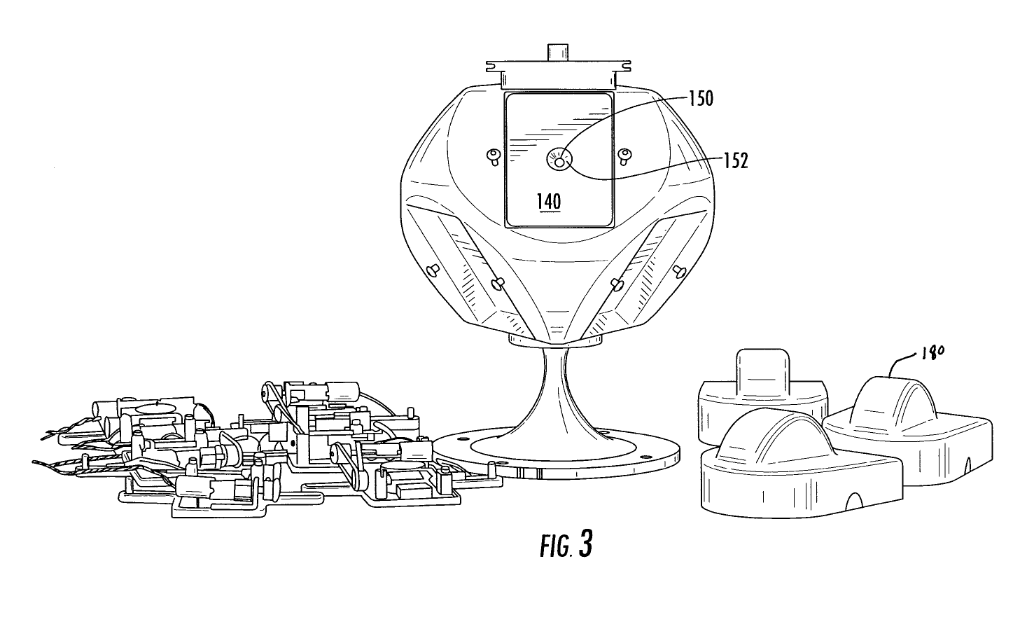

Each cube face 110 defines a receptacle 120 below a surface plane of cube face 110. The receptacle 120 provides for a location for a detector 10 as seen and described in reference to FIG. 1. As seen in FIG. 2, the receptacle 120 may be set within an interior of a second larger receptacle 130. Receptacle 130 will accommodate a collimator 140 as best seen in FIG. 3. Collimator 140 additionally defines an aperture 15 which is perpendicular relative to the Collimator 140 as well as the multiple film layers 12 of detector 10. While the illustrated embodiment of the collimator 140 is seen in the form of a rectangular plate, the size and dimensions of the collimator may be varied. As is well known in the art, the collimator may be constructed of a shielding material such that the body of the collimator will block radiation from reaching the detector but for the radiation aligned with the pathway of collimator aperture 150.

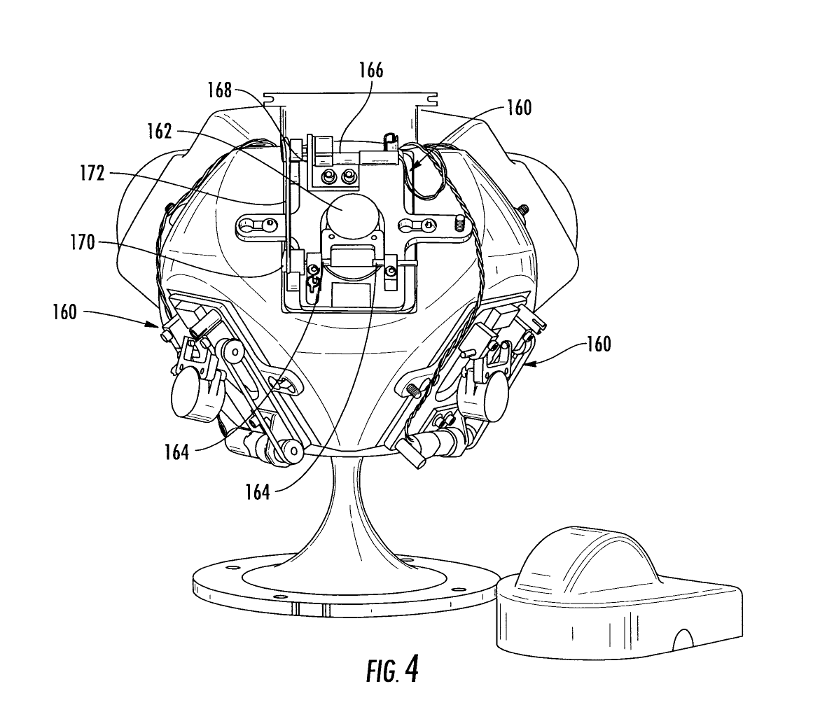

The opening 150 within collimator 140 is designed to provide a 96 degree field of view. When utilized with a radiation detection apparatus having a similar collimator on each of six cube faces, the 96 degree field of view provides sufficient overlap such that a full 360° degree coverage is provided and covers a solid angle of 4π steradians. As seen in reference to FIG. 3, the collimator surfaces through which the aperture 150 extends, defines an increased diameter taper surface 152. In the illustrated embodiment, it has been determined useful to have the opposing surfaces of the collimator 140 define similar tapered surfaces 152, the opposing tapers converging through the thickness of the collimator such that the opening 150 at its smallest diameter has a length approaching 0 mm. In other words, the diameter of the aperture is defined soley by the meeting of the opposing tapered surfaces 152. For optimal resolution, it has been found having the smallest aperture of the opening 150 to be a diameter of 1 mm or less will provide a pin hole opening for maximum resolution. The tapered surface dimensions of width and depth helps determine the field of view associated with the collimator along with the length of the aperture 150 which is a direct correlation to the thickness of the collimator through which the aperture is defined. Appropriate selection of aperture length, diameter and taper surface dimensions can be varied to provide the desired field of view angle As best seen in reference to FIG. 4, a positional shutter mechanism 160 can be provided which is in operative engagement with aperture 150 of Collimator 140. Numerous drive mechanisms for controlling the shutter can be utilized. As seen in reference to FIG. 4, one suitable drive mechanism for shutter 160 deploys a shield 162 which may be carried along a pair of pivot arms 164. An electric motor 166 can engage a drive wheel 168 which is responsive to a second drive wheel 170 via a connecting belt 172. The shield 162 can occupy a first position covering the collimator and a second position where the shield 162 is pivoted to a non-blocking position. Motor 166 can be responsive to a battery and can incorporate either a timer mechanism and/or a remote control. It should be noted that any number of shutter devices can be utilized to an extent that they provide a means of moving a shutter from a covering position opposite a collimator to uncovered position away from the field of view of the collimator. For instance, linear actuators, servo motors, and other methods of sliding, pivoting, or moving a shield may be implemented.

In embodiments where multiple shutters 160 are utilized on a single radiation detection apparatus, it is beneficial that each shutter be capable of operating independently. For example, one shutter associated with a collimator facing a high intensity radiation source, may need a shorter exposure interval than a different face/collimator which has a field of view directed to a lower intensity radiation source.

The electronically controlled shutters may be constructed of any suitable shielding material. The shielding is needed due to the extreme sensitivity of the photographic film or PSP layer radiation sensors. When characterizing areas of moderate dose rate (˜1 R/hr or higher), the radiation detectors would be exposed to a large amount of ‘noise’ while the device is being moved into position and removed from the area. The shutters keep noise at a minimum, opening and closing only while the device is stationary and in position.

In addition, it is possible to modify the radiation detectors such that the detectors are capable of detecting neutron, alpha, and beta particles. For neutrons, the device could be coated with Gadolinium (absorbent to neutrons) and the film layer modified to include a neutron-to-gamma film covering. Alpha particles can be detected by utilizing a UV sensitive detector layer to detect the alpha interaction with nitrogen in the air, which produces UV light. Beta particles could be detected by adding a thin layer of metal over the collimator holes to allow bremsstrahlung radiation to be generated. The dynamic range of the radiation detector apparatus described here is from a few mR/hr to a few thousand R/hr.

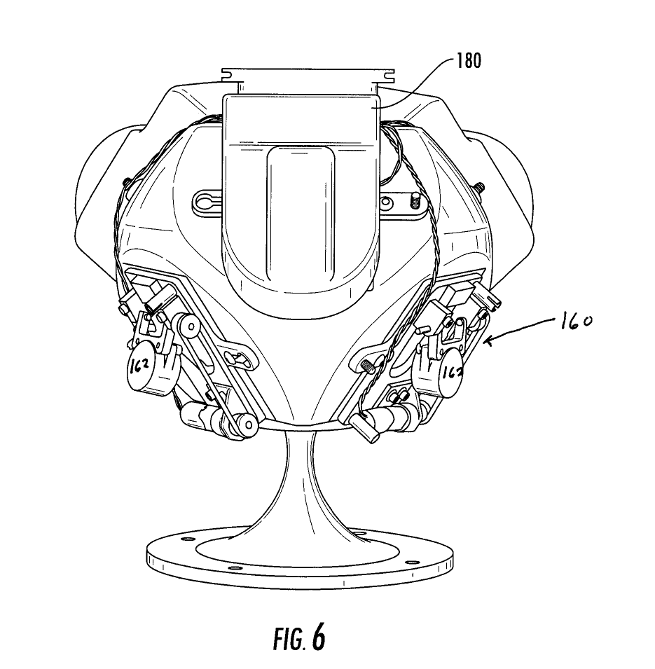

As been seen referenced to FIG. 6, a protective cover 180 may be placed over each facet 110, cover 180 providing a protective cap over the shutter mechanism 160. The protective cap 180 can consist of a number of conventional plastic materials which are readily transparent to radiation. The protective covers 180 can remain in place while the radiation detector 100 is deployed and can remain in place while shutter mechanisms 160 are operated. The cover 180 helps protect the shutter mechanism 160 and surrounding components from damage or snagging materials during deployment.

The present invention may be utilized with the various deployment vehicles as set forth in the Applicant's co-pending PCT application, PCT/US11/38250 filed on Aug. 18, 2011 and which is incorporated herein by reference. Further, the various radiation detectors described herein may be used as a substitute for the radiation detecting polymer utilized and described in the above referenced application. Software visualization and mapping techniques, similar to those in the co-pending application, can be easily adapted by one having ordinary skill in the art to utilize data obtained from the present radiation detectors and radiation detecting apparatuses.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention and claims. In addition, it should be understood that aspects of the various embodiments might be interchanged, both in whole, and in part. Therefore, the spirit and scope of the invention should not be limited to the description of the preferred versions contained therein.

What is claimed:

1. A radiation detector comprising:
a housing;
a first film layer and a second film layer, the first and second film layers positioned within the housing;
a first attenuator layer and a second attenuator layer positioned within said housing, the first and second attenuator layers positioned opposite at least one of said first film layer and said second film layer.

2. The radiation detector as set forth in claim 1, wherein the first and the second film layers are selected from the group consisting of X-ray films, and PSP plates.

3. The radiation detector as set forth in claim 1, wherein the film layers and the attenuator layers form alternating layers.

4. The radiation detector as set forth in claim 1, wherein the film layers and the attenuator layers are flat.

5. The radiation detector as set forth in claim 1, wherein the film layers and the attenuator layers are curved.

6. A radiation detecting apparatus comprising:
a housing defining an interior surface and an exterior surface, the housing further defining a plurality of collimators extending from the outer surface to the inner surface; and,
a radiosensitive detector positioned along the interior of the housing and in further communication with the plurality of collimators, the radiosensitive detector comprising multiple layers of radiation sensitive films positioned between alternating layers of attenuators.

7. The apparatus as set forth in claim 6, wherein the housing is in the form of a sphere and the radiosensitive detector material conforms to a shape of the interior surface of the housing.

8. The apparatus as set forth in claim 6, wherein the housing is in the form of a polyhedron and the radiosensitive detector material conforms to a shape of the interior surface of the housing.

9. The apparatus as set forth in claim 6 wherein the housing defines a cavity and a radiation shield is positioned within the cavity, the radiosensitive detector material positioned between the interior surface of the housing and the radiation shield.

10. A radiation detection apparatus comprising:
a housing defining a plurality of facets in unique planes, each facet adapted for operatively engaging a radiation detector material positioned along an interior face of a respective facet; and,
a plurality of collimators defined by the housing, each of the collimators in communication with the radiation detector material.

11. The radiation detection apparatus as set forth in claim 10, wherein the plurality of collimators are in selective communication with a radiation blocking shutter responsive to at least one of a timer or a switching mechanism such the collimator's exposure to radiation may be controlled by the operation of the shutter from a first blocking position to an open position.

12. A radiation detection apparatus comprising:
a housing defining at least 6 multi-faceted exterior surfaces, each of the individual surface facets defining therein a receptacle for containing a radiation detector; and,
a collimator positioned over each individual surface facet such that an opening defined within the collimator is perpendicular to a surface of the radiation detector, the collimator further defining a 96 degree field of view.

13. The radiation detection apparatus as set forth in claim 12, wherein at least of one of the collimators are in selective communication with a radiation blocking shutter responsive to at least one of a timer or a switching mechanism such that the collimator's exposure to radiation may be controlled by the operation of the shutter from a first blocking position to an open position.

14. The radiation detection apparatus as set forth in claim 12 wherein the radiation detector comprises a first film layer and a second film layer, the first and second film layers positioned within the housing; and,
a first attenuator layer and a second attenuator layer positioned opposite at least one of said first film layer and said second film layer.

15. The radiation detection apparatus as set forth in claim 12, wherein the housing further defines a cavity therein and a radiation shield is positioned within the cavity, the radiation detector positioned between the interior surface of the housing and the radiation shield.

16. The radiation detector apparatus as set forth in claim 12, wherein a protective cap is placed over the radiation blocking shutter, the cap spaced a distance away from the surface of the shutter such as the shutter can operate with the protective cap in place.

17. A process of detection and identification of one or more of a gamma-ray, alpha-particle, beta-particle, and/or neutron emission source present in a multi-surfaced environment such as a reactor, fuel and isotope processing facilities, laboratories, glove boxes, isolators, and outdoor environments, comprising the steps of:
deploying a radiation detection apparatus defining a plurality of multi-faceted exterior surfaces and each surface facet defining therein a receptacle having a radiation detector therein, the radiation detector defining multiple film layers separated by intervening layers of an attenuator and the radiation detector in further communication with a collimator;
exposing each radiation detector to ambient conditions for a controlled period of time; and
processing said radiation detector to determine information of at least one of a type, quantity, or location of a radiation source present with the environment in which the radiation detection apparatus was deployed.

18. The radiation detecting apparatus according to claim 12, wherein said collimator further defines a pair of opposing tapered surfaces on opposite sides of the collimator.

19. The radiation detecting apparatus according to claim 18, wherein the diameter of the aperture at its narrowest point through the collimator is 1 mm or less.
